(19) United States
(12) Patent Application Publication
(10) Pub. No.: US 2026/0103549 A1
(43) Pub. Date: Apr. 16, 2026

(54) PROCESS FOR THE PRODUCTION OF CATALYST FOR POLYOLEFIN SYNTHESIS

(71) Applicant: SABIC GLOBAL TECHNOLOGIES B.V., Bergen op Zoom (NL)

(72) Inventors: Yizu ZHU, Katy, TX (US); Rama Kumar ALLADA, Bellaire, TX (US); Hua BAI, Manvel, TX (US); Hareesh Shamrao DESHPANDE, Bangalore (IN); Sivalingam GUNASEKARAN, Bengaluru (IN); Jens PANITZKY, Dorsten (DE); Mohammad SHAFIEI, Missouri City, TX (US); Shaneesh VADAKE KULANGARA, Veldhoven (NL); Hongbing JIAN, Sugar Land, TX (US)

(21) Appl. No.: 19/117,287

(22) PCT Filed: Sep. 28, 2023
(86) PCT No.: PCT/EP2023/076901

§ 371 Date: Mar. 31, 2025

(30) Foreign Application Priority Data
Oct. 3, 2022 (EP) 22199420.5

(51) Int. Cl. C08F 4/648; B01J 19/00; B01J 19/06; B01J 19/18

(52) U.S. Cl. CPC C08F 4/648; B01J 19/006; B01J 19/0066; B01J 19/06; B01J 19/18; B01J 2219/00029; B01J 2219/00033; B01J 2219/00768

(57) ABSTRACT

A process involving the steps of:
(a) supplying reactants to a reactor vessel (A);
(b) optionally, supplying a solvent to the reactor vessel;
(c) subjecting the contents of the reactor vessel to reactive conditions to obtain a product mixture (1) including a reaction product;
(d) removing the product mixture (1) from the reactor vessel and supplying it to a decanter system (B);
(e) in the decanter system, separating the reaction product from the product mixture by decantation and removal of a stream (2) including the reaction product;
(f) removal of a stream (3) including the solvent from the decanter system;
wherein at least one of the reactants supplied in step (a) is supplied in a form dissolved in a solvent, or a solvent is supplied in step (b).

### CROSS REFERENCE TO RELATED APPLICATIONS

This application is a National Stage application of PCT/EP2023/076901, filed Sep. 28, 2023, which claims the benefit of European Application No. 22199420.5 filed Oct. 3, 2022, all of which are incorporated by reference in their entirety herein.

### BACKGROUND

The present invention relates to a process for the production of catalyst materials, in particular to a process for the production of catalysts for the synthesis of polyolefins such as polyethylenes. The process according to the present invention allows for the production of catalyst materials having a particularly desirable small average particle size, at desirably high productivity rates.

Polyolefins are the world's most universally applied thermoplastic polymer materials. They are suitable for use in the manufacture of a plethora of applications, via conveniently operable manufacturing processes, at desirable process economics.

Within the genus of polyolefins, a variety of polymer materials has been develop since the original conception of the family of materials. In this group, a number of species are typically produced via catalysed processes. Ongoing developments in the field of catalysts for polyolefin synthesis have led to the development of a wide variety of grades of polyolefins, and continue to do so.

A particular strive in the field of the synthesis of catalyst materials for the manufacture of polyolefin materials is to have available particulate catalyst materials that exhibit the appropriate catalytic activity that allows for the synthesis of the desired polyolefin materials at desirable process economics, wherein the particulate catalyst materials have a low average particle size. In particular for the manufacture of polyolefin material types that have a high molecular weight, such as the polyethylene materials of the ultra-high molecular weight (UHMWPE) type, it is required for production of high quality materials at high productivity that the catalyst materials that are employed in such manufacturing processes have a low average particle size. UHMWPE as used in the context of the present invention may be understood to relate to polyethylene homo- or copolymers having a molecular weight of ≥1,000,000 g/mol. The UHMWPE may from example be a copolymer of ethylene and 1-butene, 1-hexene or 1-octene. The molecular weight of the UHMWPE may for example be determined by applying the method of ASTM D4020-11, based on determining the intrinsic viscosity via the method described therein.

### SUMMARY

To arrive at this objective, it has now been found that such can be achieved by a process involving the steps of:
(a) supplying reactants to a reactor vessel (A);
(b) optionally, supplying a solvent to the reactor vessel;
(c) subjecting the contents of the reactor vessel to reactive conditions to obtain a product mixture (1) comprising a reaction product;
(d) removing the product mixture (1) from the reactor vessel and supplying it to a decanter system (B);
(e) in the decanter system, separating the reaction product from the product mixture by decantation and removal of a stream (2) comprising the reaction product;
(f) removal of a stream (3) comprising the solvent from the decanter system;
wherein at least one of the reactants supplied in step (a) is supplied in a form dissolved in a solvent, or a solvent is supplied in step (b).

Such process allows for the production of a catalyst system having a low average particle size, such as 2-4 μm, having a high purity, at high procedural efficiency.

### BRIEF DESCRIPTION OF DRAWINGS

The present teachings are described hereinafter with reference to the accompanying schematic drawings in which examples of the invention are shown and in which like reference numbers indicate the same or similar elements.

A non-limiting reflection of a reactor embodiment is displayed in FIG. 1; and

FIG. 2 provides a presentation of a process lay-out.

### DETAILED DESCRIPTION

The stream (3) may be recycled back to the reaction vessel via step (b).

The reactants that are supplied to the reactor vessel in step (a) may for example include:
(i) a magnesium-containing compound of formula MgR₂, wherein R is Cl, Br, I, For a moiety selected from methoxy, ethoxy, n-propoxy, or isopropoxy;
   and/or
(ii) a titanium-containing compound of formula TiOₓ(OR)₄₋₂ₓ, wherein x is 0 or 1, and R is a hydrocarbon moiety comprising ≥1 and ≤10 carbon atoms, preferably a moiety selected from methyl, ethyl, propyl, n-butyl, isobutyl, or n-hexyl;
   and/or
(iii) a metal-containing compound having the formula MRₙX₃₋ₙ, wherein
   M is a metal selected from the CAS group of elements IIIA, preferably from aluminium and boron;
   R is a hydrocarbon moiety comprising ≥1 and ≤10 carbon atoms, preferably a moiety selected from methyl, ethyl, propyl, n-butyl, isobutyl, or n-hexyl;
   n is an integer selected from 0, 1, or 2; and
   X is a halogen atom, preferably selected from chlorine and bromine;
   and/or
(iv) a silicon-containing compound of formula RₘSiCl₄₋ₘ, wherein
   R is a hydrocarbon moiety comprising ≥1 and ≤10 carbon atoms, preferably a moiety selected from methyl, ethyl, propyl, n-butyl, isobutyl, or n-hexyl; and
   m is an integer selected from 0, 1, or 2;
   and/or
(v) optionally, an organoaluminium compound of formula AlR₃, wherein R is a hydrocarbon moiety comprising ≥1 and ≤10 carbon atoms, preferably a moiety selected from methyl, ethyl, propyl, n-butyl, isobutyl, or n-hexyl.

The magnesium-containing compound (i) may for example be selected from magnesium methylate, magnesium ethylate, magnesium isopropylate, magnesium ethylethylate, magnesium dichloride, and magnesium dibromide. Preferably, the magnesium-containing compound (i) is magnesium ethylate.

The titanium-containing compound (ii) may for example be selected from tetraethyl titanate, tetraisopropyl titanate, tetra n-propyl titanate, tetraisobutyl titanate, tetra n-butyl titanate, and tetra n-octyl titanate. Preferably, the titanium-containing compound (ii) is tetra isobutyl titanate or tetra n-butyl titanate.

The metal-containing compound (iii) may for example be selected from aluminium trichloride, ethyl aluminium dibromide, ethyl aluminium dichloride, propyl aluminium dichloride, n-butyl aluminium dichloride, isobutyl aluminium dichloride, diethyl aluminium chloride, and diisobutyl aluminium chloride. Preferably, the metal-containing compound (iii) is selected from ethyl aluminium dichloride, diethyl aluminium chloride, and diisobutyl aluminium chloride. More preferably, the metal-containing compound (iii) is ethyl aluminium dichloride.

The silicon-containing compound (iv) may for example be selected from silicon tetrachloride, methyl trichlorosilane, ethyl trichlorosilane, n-propyl trichlorosilane, isopropyl trichlorosilane, n-butyl trichlorosilane, isobutyl trichlorosilane, n-pentyl trichlorosilane, n-hexyl trichlorosilane, n-octyl trichlorosilane, isooctyl trichlorosilane, vinyl trichlorosilane, phenyl trichlorosilane, dimethyl dichlorosilane, diethyl dichlorosilane, isobutylmetyl dichlorosilane, diisopropyl dichlorosilane, diisobutyl dichlorosilane, isobutylisopropyl dichlorosilane, dicyclopentyl dichlorosilane, cyclohexylmethyl dichlorosilane, phenylmethyl dichlorosilane, diphenyl dichlorosilane, trimethyl chlorosilane, and triethyl chlorosilane. Preferably, the silicon-containing compound (iv) is silicon tetrachloride.

The organoaluminium compound (v) may for example be selected from triethyl aluminium, triisobutyl aluminium, tri-n-hexyl aluminium, and trioctyl aluminium. Preferably, the organoaluminium compound (v) is triisobutyl aluminium.

For example,
the magnesium-containing compound (i) may be magnesium ethylate;
the titanium-containing compound (ii) may be isobutyl titanate or tetra n-butyl titanate;
the metal-containing compound (iii) may be ethyl aluminium dichloride; and
the silicon-containing compound (iv) may be silicon tetrachloride.

The step (c) may for example be conducted at a temperature of ≥50° C. and ≤70° C., preferable of ≥55° C. and ≤65° C. The step (c) may for example be conducted under a pressure ≥100 and ≤1,000 kPa, preferably of ≥150 and ≤500 kPa. The step (c) may for example be conducted during a reaction period of ≤5 hrs, preferably of ≥1 and ≤3 hrs. The step (c) may for example be conducted at a temperature of ≥50° C. and ≤70° C., under a pressure of ≥100 and ≤1,000 kPa. Preferably, the step (c) may for example be conducted at a temperature of ≥50° C. and ≤70° C., under a pressure of ≥100 and ≤1,000 kPa, during a reaction period of ≤5 hrs. More preferably, the step (c) may for example be conducted at a temperature of ≥55° C. and ≤65° C., under a pressure of ≥150 and ≤500 kPa, during a reaction period of ≥1 and ≤3 hrs.

The solvent may for example be an organic solvent, preferably a C₄-C₂₀ non-polar hydrocarbon, more preferably a compound selected from isobutane, isopentane, hexane, cyclohexane, heptane, methyl cyclohexane, n-octane, iso-octane, toluene, xylene, ethylbenzene, isopropylbenzene, ethyltoluene, n-propylbenzene, and diethylbenzene. It is particularly preferable that the solvent is hexane.

The contents of the reactor in step (c) may for example comprise ≥2.0 and ≤20.0 wt %, preferably ≥2.0 and ≤10.0 wt %, of the reactants, with regard to the total weight of the reactor contents. The steps (a)-(d) may be conducted as a batch process. The steps (e)-(f) may be conducted in continuous operation.

The reactor vessel may for example be a stirred tank reactor that is equipped with an agitation system (C), preferably wherein the agitation system provides a mixing power density of ≥15.0 W/kg, preferably of ≥25.0 and ≤75.0 W/kg. The application of such mixing power density may be understood to contribute to achieving a desirable fine particle size of the catalyst that is produced according to the process, which in turn is beneficial to achieve an improved heat and mass transfer during polymerisation of the polyolefin product using the catalyst, for example in polymerisation of ethylene, and may lead to achieving a higher polymerisation reaction rate. Furthermore, application of such high mixing powder is considered not only to allow for the production of catalyst particles having such fine particle size, it also is considered to contribute to an even distribution of the size of the particles, that is, to reduce the formation of excessive quantities of fines and large size particles.

The agitation system may for example comprise a pitched blade turbine, preferably wherein the pitch angle of the impeller blades of the turbine is ≥10° and ≤60°. Such pitched blade turbine may for example comprise 1, 2 or 3 impellers (D), wherein, in the case that the turbine comprises 2 or 3 impellers, the spacing between the impellers is ≥0.5·Dᵢₘₚ and ≤1.2·Dᵢₘₚ, wherein Dᵢₘₚ is the diameter of the impellers.

The tank reactor may comprise evenly distributed vertically placed baffles (E) extending between 0.05·Dᵣ and 0.1·Dᵣ inwards into the reactor, wherein Dᵣ is the inner diameter of the tank reactor, preferably the tank reactor comprises 3 to 6 baffles.

The reactor may for example be operated in such a way that the top most impeller of the agitation system is submerged in the contents in the reactor vessel to a depth (F) of at least 0.3·Dᵢₘₚ, wherein Dᵢₘₚ is the diameter of the impeller. Operating the reactor at such level of contents is considered to contribute to an even flow pattern throughout the reaction mixture during the catalyst synthesis process, and thus may contribute to a well-balanced production of catalyst particles of similar constitution and morphology.

The turbine may comprise one or more impellers, each having a diameter Dᵢₘₚ of ≥0.4·Dᵣ, wherein Dᵣ is the inner diameter of the tank reactor, preferably wherein Dᵢₘₚ is ≥0.5·Dᵣ and ≤0.75·Dᵣ.

The average particle size D₅₀ of the catalyst particles that are present in the stream (2) may for example be ≤4.0 μm, preferably ≥2.0 and ≤4.0 μm.

A non-limiting reflection of a reactor embodiment that may be used in the process of the invention is displayed in FIG. 1, wherein the symbols are to be used stood as to indicate:
A Reactor vessel
C Agitation system
D Impellers
E Baffles
F Depth of impelled submergence
Dᵣ Inner reactor diameter
D_{imp′} Impeller diameter

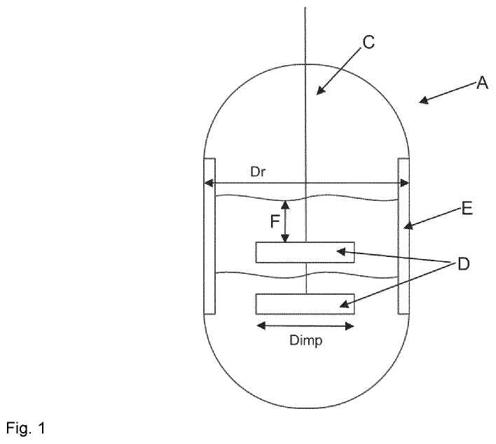

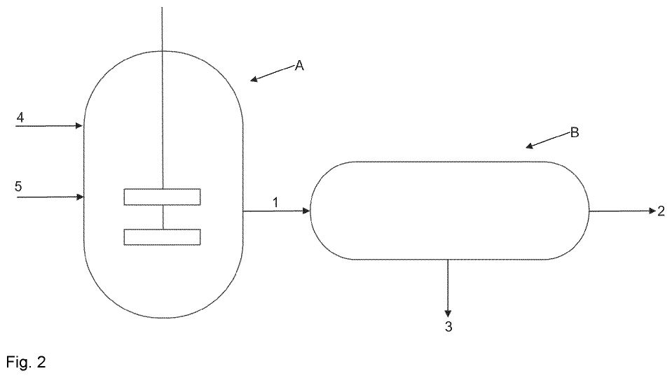

Furthermore, FIG. 2 provides a presentation of a process lay-out that may be suitable for performing the process according to the present invention, wherein
A Reactor vessel
B Decanter vessel
1 Product mixture
2 Reaction product stream
3 Solvent
4 Reactants
5 Solvent.

The invention will now be illustrated by the following non-limiting example.

To a stirred tank reactor, a reaction mixture of titanium tetrabutoxide, magnesium ethylate, ethyl aluminium dichloride, and tetrachlorosilane, as 5 wt % solution in hexane. The reaction mixture was subjected to reaction conditions, being a temperature of 60° C., at a pressure of 200 kPa, for a period of 2 hrs. After that, the contents of the reactor were supplied to a decanter system, involving multiple decanting steps. Decanting was performed at 50° C., to obtain a concentrated mother liquor catalyst solution of 30 wt % catalyst material, having an average particle size of 2-4 μm, in hexane. The free ionic Ti concentration was determined to be less than 5 ppm in the produced catalyst. During decantation, the tank reactor was available for use in production of a subsequent batch of the catalyst product, thus contributing to the improvement of the space-time yield of the process.

This process allowed for the production of a highly pure catalyst product having a low average particle size, whilst the process could be operated at desirable process efficiency.

1. A process for the production of a catalyst, the process involving the steps of:
(a) supplying reactants to a reactor vessel (A);
(b) optionally, supplying a solvent to the reactor vessel;
(c) subjecting the contents of the reactor vessel to reactive conditions to obtain a product mixture (1) comprising a reaction product;
(d) removing the product mixture (1) from the reactor vessel and supplying it to a decanter system (B);
(e) in the decanter system, separating the reaction product from the product mixture by decantation and removal of a stream (2) comprising the reaction product;
(f) removal of a stream (3) comprising the solvent from the decanter system;
wherein at least one of the reactants supplied in step (a) is supplied in a form dissolved in a solvent, or a solvent is supplied in step (b).

2. The process according to claim 1, wherein the stream (3) is recycled back to the reaction vessel via step (b).

3. The process according to claim 1, wherein the reactants that are supplied to the reactor vessel in step (a) include:
(i) a magnesium-containing compound of formula MgR₂, wherein R is Cl, Br, I, For a moiety selected from methoxy, ethoxy, n-propoxy, or isopropoxy;
and/or
(ii) a titanium-containing compound of formula TiOₓ(OR)₄₋₂ₓ, wherein x is 0 or 1, and R is a hydrocarbon moiety comprising ≥1 and ≤10 carbon atoms;
and/or
(iii) a metal-containing compound having the formula MRₙX₃₋ₙ, wherein
M is a metal selected from the CAS group of elements IIIA;
R is a hydrocarbon moiety comprising ≥1 and ≤10 carbon atoms;
n is an integer selected from 0, 1, or 2; and
X is a halogen atom,
and/or
(iv) a silicon-containing compound of formula RₘSiCl₄₋ₘ, wherein
R is a hydrocarbon moiety comprising ≥1 and ≤10 carbon atoms; and
m is an integer selected from 0, 1, or 2;
and/or
(v) an organoaluminium compound of formula AlR₃, wherein R is a hydrocarbon moiety comprising ≥1 and ≤10 carbon atoms.

4. The process according to claim 1, wherein the step (c) is conducted:
at a temperature of ≥50° C. and ≤70° C.; and/or
under a pressure ≥100 and ≤1,000 kPa; and/or
during a reaction period of ≤5 hrs.

5. The process according to claim 1, wherein the solvent is an organic solvent.

6. The process according to claim 1, wherein the contents of the reactor in step (c) comprise ≥2.0 and ≤20.0 wt % of the reactants, with regard to the total weight of the reactor contents.

7. The process according to claim 1, wherein the steps (a)-(d) are conducted as a batch process.

8. The process according to claim 1, wherein the steps (e)-(f) are conducted in continuous operation.

9. The process according to claim 1, wherein the reactor vessel is a stirred tank reactor that is equipped with an agitation system (C).

10. The process according to claim 9, wherein the agitation system comprises a pitched blade turbine.

11. The process according to claim 9, wherein the pitched blade turbine comprises 1, 2 or 3 impellers (D), wherein, in the case that the turbine comprises 2 or 3 impellers, the spacing between the impellers is ≥0.5·Dᵢₘₚ and ≤1.2·Dᵢₘₚ, wherein Dᵢₘₚ is the diameter of the impellers.

12. The process according to claim 9, wherein the tank reactor comprises evenly distributed vertically placed baffles (E) extending between 0.05·Dᵣ and 0.1·Dᵣ inwards into the reactor, wherein Dᵣ is the inner diameter of the tank reactor.

13. The process according to a claim 9, wherein the reactor is operated in such a way that the top most impeller of the agitation system is submerged in the contents in the reactor vessel to a depth (F) of at least 0.3·Dᵢₘₚ, wherein Dᵢₘₚ is the diameter of the impeller.

14. The process according to claim 9, wherein the turbine comprises one or more impellers, each having a diameter Dᵢₘₚ of ≥0.4·Dᵣ, wherein Dᵣ is the inner diameter of the tank reactor.

15. The process according to claim 1, wherein the average particle size D₅₀ of the catalyst particles that are present in the stream (2) is ≤4.0 μm.
